(19) United States
(12) Patent Application Publication
(10) Pub. No.: US 2013/0013363 A1
(43) Pub. Date: Jan. 10, 2013

(54) Management of Project Development

(75) Inventors: David D. Jones, Plano, TX (US); Deborah J. Mueller, (US); Paul C. Grumann, Leavenheath (GB)

(73) Assignee: Bank of America Corporation, Charlotte, NC (US)

(21) Appl. No.: 13/176,892

(22) Filed: Jul. 6, 2011

(51) Int. Cl. G06Q 10/00

(52) U.S. Cl. 705/7.15

(57) ABSTRACT

According to some embodiments, a project management system for managing projects in a plurality of stages comprising at least a first stage and a second stage includes a development module, a support module, and a management module. Each stage represents a stage required for completion before the project enters production. The development module is operable to receive a first stage status update. The first stage status update indicates that a development team has completed the first stage for a project. The support module is operable to receive an approval from a support team approving the development team's completion of the first stage. The management module is communicatively coupled to the development module and the support module and is operable to determine whether the development team is authorized to perform actions towards completion of the second stage based on whether the approval is received for the first stage.

### TECHNICAL FIELD OF THE INVENTION

The present invention relates generally to project management and more specifically to management of project development.

### BACKGROUND OF THE INVENTION

Project management is the discipline of planning, implementing, and supporting a project. Project management may include management of a project in three phases: development, production, and support. Development of a project may include pre-production tasks such as planning and organizing. Production of a project may include the implementation of a project once the project has been developed. Support of a project may include subsequent monitoring and management of a project after production. The support phase of project management may include providing resources for a project so that the project may achieve certain goals and objectives identified during the development phase.

### SUMMARY OF THE INVENTION

According to some embodiments, a project management system for managing projects in a plurality of stages comprising at least a first stage and a second stage includes a development module, a support module, and a management module. Each stage of the plurality of development stages represents a stage required for completion before the project enters production. The development module is operable to receive a first stage status update. The first stage status update indicates that a development team has completed the first stage for a project. The support module is operable to receive an approval from a support team approving the development team's completion of the first stage. The management module is communicatively coupled to the development module and the support module and is operable to determine whether the development team is authorized to perform actions towards completion of the second stage based on whether the approval is received for the first stage.

Certain embodiments of the invention may provide one or more technical advantages. A technical advantage of one embodiment may include the capability to inject support phase input and oversight into the development of a project. A technical advantage of one embodiment may also include the capability to track and monitor a project and the support phase approval of the development of a project. A technical advantage of one embodiment may also include the capability to improve knowledge transfer between the development phase and the support phase of a project.

Various embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 shows a project management system according to one embodiment;

FIG. 2 shows a project tracker according to one embodiment; and

FIG. 3 shows an example method for managing development of a project according to one embodiment.

### DETAILED DESCRIPTION OF THE INVENTION

It should be understood at the outset that, although example implementations of embodiments of the invention are illustrated below, the present invention may be implemented using any number of techniques, whether currently known or not. The present invention should in no way be limited to the example implementations, drawings, and techniques illustrated below. Additionally, the drawings are not necessarily drawn to scale.

Project management is the discipline of planning, implementing, and supporting a project. Project management may include management of a project in three phases: development, production, and support. Development of a project may include pre-production tasks such as planning and organizing. Production of a project may include the implementation of a project once the project has been developed. Support of a project may include subsequent monitoring and management of a project after production. The support phase of project management may include providing resources for a project so that the project may achieve certain goals and objectives identified during the development phase.

In some circumstances, the development phase may be divided into multiple stages and sub-stages. In these examples, each stage may be arranged linearly such that a second stage may not be commenced until a first stage is completed. In some examples, however, stages are not arranged linearly. For examples, some stages may progress simultaneously.

Each stage or sub-stage may be associated with one or more parameters. A parameter is a characteristic of the project that affects the viability or expense of the project. As one example, a development team may estimate expected infrastructure cost of a project during an infrastructure stage of the development phase. In this example, infrastructure cost is a parameter of the stage. If the scope of the project changes in later stages, the infrastructure stage may be reopened, and the development team may update the estimated expected infrastructure cost.

One example of a project may include provisioning a new enterprise software application. In this example, the development phase may include the planning and organizing of the software application, including the writing of code for the software application. The production phase may include the roll-out of the software application, including transferring users from old programs to the new software application. The support phase may include maintenance of the new software application, including the provisioning and maintenance of servers and other resources necessary to run the software application.

An enterprise may include any individual, business, or organization. One example of an enterprise may include a financial enterprise. A financial enterprise may include any individual, business, or organization that engages in financial activities, which may include, but are not limited to, banking and investment activities such as maintaining accounts (e.g., transaction accounts, savings accounts, credit accounts, investment accounts, insurance accounts, portfolios, etc.), receiving deposits, crediting accounts, debiting accounts, extending credit to account holders, purchasing securities, providing insurance, and supervising a customer's portfolio.

A financial enterprise may provide a variety of financial products. Examples of financial products may include, but are not limited to, account services such as maintaining accounts, receiving deposits, crediting accounts, debiting accounts, extending credit, purchasing securities, providing insurance, and portfolio management.

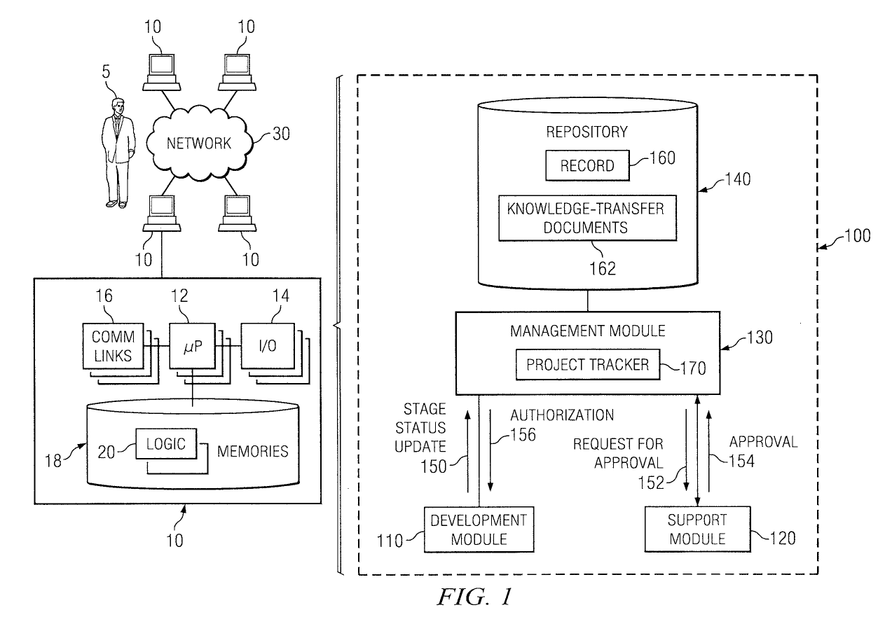

FIG. 1 shows a project management system 100 according to one embodiment. The project management system 100 of FIG. 1 features a development module 110, a support module 120, a management module 130, and a repository 140, that may be implemented by one or more computer systems 10.

Users 5 may access system 100 through computer systems 10. Users 5 may include any individual, group of individuals, entity, machine, and/or mechanism that interacts with computer systems 10. Examples of users 5 include, but are not limited to, a manager, executive, review board, accountant, engineer, technician, contractor, agent, and/or employee. Users 5 may be associated with an organization. An organization may include any social arrangement that pursues collective goals. One example of an organization is a business. A business is an organization designed to provide goods or services, or both, to consumers, governmental entities, and/or other businesses. Examples of a business may include, but are not limited to, financial enterprises, agriculture and mining businesses, manufacturers, real estate companies, retailers and distributors, service businesses, transportation companies, and utility companies. A business may include both for-profit and not-for-profit businesses. An organization may also include multiple businesses. For example, an organization may control businesses in multiple jurisdictions throughout the world. Examples of organizations are not limited to businesses. For example, an organization can itself be a government entity. In one example embodiment, system 100 is associated with a financial enterprise, and user 5 is an employee or representative of the financial enterprise.

Computer system 10 may include processors 12, input/output devices 14, communications links 16, and memory 18. In other embodiments, computer system 10 may include more, less, or other components. Computer system 10 may be operable to perform one or more operations of various embodiments. Although the embodiment shown provides one example of computer system 10 that may be used with other embodiments, such other embodiments may utilize computers other than computer system 10. Additionally, embodiments may also employ multiple computer systems 10 or other computers networked together in one or more public and/or private computer networks, such as one or more networks 30.

Processors 12 represent devices operable to execute logic contained within a medium. Examples of processor 12 include one or more microprocessors, one or more applications, and/or other logic. Computer system 10 may include one or multiple processors 12.

Input/output devices 14 may include any device or interface operable to enable communication between computer system 10 and external components, including communication with a user or another system. Example input/output devices 14 may include, but are not limited to, a mouse, keyboard, display, and printer.

Network interfaces 16 are operable to facilitate communication between computer system 10 and another element of a network, such as other computer systems 10. Network interfaces 16 may connect to any number and combination of wireline and/or wireless networks suitable for data transmission, including transmission of communications. Network interfaces 16 may, for example, communicate audio and/or video signals, messages, internet protocol packets, frame relay frames, asynchronous transfer mode cells, and/or other suitable data between network addresses. Network interfaces 16 connect to a computer network or a variety of other communicative platforms including, but not limited to, a public switched telephone network (PSTN); a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable network interfaces; or any combination of the preceding.

Memory 18 represents any suitable storage mechanism and may store any data for use by computer system 10. Memory 18 may comprise one or more tangible, computer-readable, and/or computer-executable storage medium. Examples of memory 18 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

In some embodiments, memory 18 stores logic 20. Logic 20 facilitates operation of computer system 10. Logic 20 may include hardware, software, and/or other logic. Logic 20 may be encoded in one or more tangible, non-transitory media and may perform operations when executed by a computer. Logic 20 may include a computer program, software, computer executable instructions, and/or instructions capable of being executed by computer system 10. Example logic 20 may include any of the well-known OS2, UNIX, Mac-OS, Linux, and Windows Operating Systems or other operating systems. In particular embodiments, the operations of the embodiments may be performed by one or more computer readable media storing, embodied with, and/or encoded with a computer program and/or having a stored and/or an encoded computer program. Logic 20 may also be embedded within any other suitable medium without departing from the scope of the invention.

Various communications between computers 10 or components of computers 10 may occur across a network, such as network 30. Network 30 may represent any number and combination of wireline and/or wireless networks suitable for data transmission. Network 30 may, for example, communicate internet protocol packets, frame relay frames, asynchronous transfer mode cells, and/or other suitable data between network addresses. Network 30 may include a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable communication links; or any combination of the preceding. Although the illustrated embodiment shows one network 30, teachings of certain embodiments recognize that more or fewer networks may be used and that not all elements may communicate via a network. Teachings of certain embodiments also recognize that communications over a network is one example of a mechanism for communicating between parties, and any suitable mechanism may be used.

Development module 110 provides an interface between a development team and management module 130. A development team may include one or more users 5. In some examples, development module 110 may allow the development team to report when stages of development are completed. Development module 110 may also inform the development team when the development team is authorized to perform actions towards completion of a new stage of development.

Support module 120 provides an interface between a support team and management module 130. A support team may include one or more users 5. In some examples, support module 120 may allow the support team to approve the development team's completion of a stage. For example, the support team may review development of a project at various stages to ensure that the project does not create burdensome support issues. As one example, the support team may recognize support costs and withhold approval of a stage until the development team addresses the support costs (such as reducing support costs or budgeting for support costs). As another example, the support team may withhold approval of a stage until the development team provides additional documentation and information regarding the project.

Management module 130 tracks and manages projects. As one example, management module 130 may track when the development team completes a stage of a project and when the support team approves the development team's completion of a stage of a project. As another example, management module 130 may determine whether the development team is authorized to perform actions towards completion of a second stage based on whether approval is received from the support team for the first stage.

As yet another example, management module 130 may determine that a parameter of a stage has changed and that the stage should he reopened. In this example, management module 130 may determine whether the development team is still authorized to perform actions towards completion of later stages based on the reopening of the prior stage. For example, a development team may estimate expected infrastructure cost of a project during an infrastructure stage of the development phase. In this example, infrastructure cost is a parameter of the infrastructure stage. If the scope of the project changes in later stages, the infrastructure stage may be reopened. Reopening of the infrastructure stage may have several consequences in some circumstances. First, the infrastructure stage may remain open until development team updates the estimated expected infrastructure cost. Also, the development team may be required to obtain approval of the infrastructure stage from the support team. By reopening the infrastructure stage, the development team may be required to obtain new approval from the support team in light of the updated infrastructure cost. In addition, reopening the infrastructure stage may suspend approval for later stages. For example, if the development team needed approval of the infrastructure stage before proceeding to later stages, the development team may be required to obtain new approval for the infrastructure stage before the development team is authorized to resume the later stages.

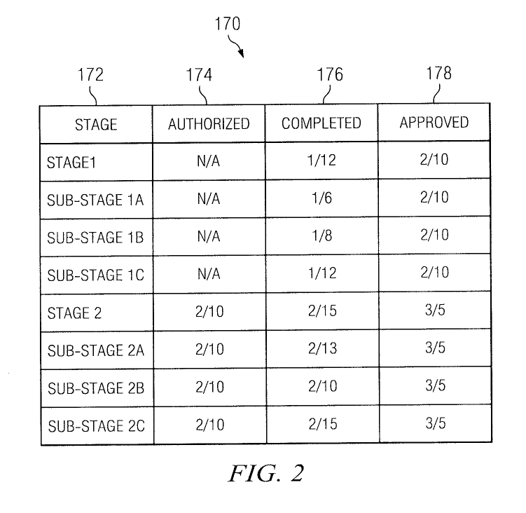

In some embodiments, management module 130 may also maintain a project tracker 170. Project tracker 170 records information pertaining to authorization and completion of stages, including, but not limited to, information regarding approval, status, parameters, and documents related to each stage. Project tracker 170 is described in greater detail with regard to FIG. 2.

Repository 140 stores project information. In some embodiments, repository 140 stores records 160 and knowledge-transfer documents 162. Record 160 is a record of the approval of the development team's completion of a stage. For example, record 160 may identify when the support team approved a certain stage. In some embodiments, record 160 may include a copy of a signature provided by the support team. Teachings of certain embodiments recognize that storing records 160 may improve project oversight. For example, some enterprises may require that approvals from the support team be signed. If the development team cannot produce a signed approval from records 160, the development team may be restricted from commencing later stages.

Knowledge-transfer documents 162 record knowledge learned by the development team during performance of a stage. Teachings of certain embodiments recognize that storing knowledge-transfer documents may provide an efficient mechanism for transferring information from the development team to the support team. In some embodiments, certain knowledge-transfer documents 162 may be required before the support team will approve a stage. For example, if the development team authored code during a stage, the development team may be required to store knowledge-transfer documents 162 describing the code and how the support team may maintain the code.

In operation, development module 110 may transmit a stage status update 150 to management module 130. In this example, stage status update 150 may identify a stage as having been completed. In this example, stage status update 150 may include knowledge-transfer documents 162, which may be stored in repository 140. In response to receiving stage status update 150, management module 130 may update project tracker 170 and transmit a request for approval 152 to support module 120.

Support module 120 may receive approval of the stage from the support team and transmit an approval 154 to management module 130. In this example, approval 154 may include a record 160, which may be stored in repository 140. In response to receiving approval 154, management module 130 may update project tracker 170 and transmit authorization 156 to development module 110. Authorization 156 authorizes the development team to perform actions towards completion of later stages.

FIG. 2 shows project tracker 170 according to one example embodiment. Project tracker 170 tracks the status of stages 172. In this example, stages 172 include stages 1 and 2 and sub-stages 1A-1C and 2A-2C. In the illustrated example, project tracker 170 records three milestone dates for each stage 172: authorization date 174, completion date 176, and approval date 178. Authorization date 174 represents the date the development team received authorization to commence stage 172. Completion date 176 represents the date that the development team reported completion of the stage 172 to management module 130. Approval date 178 represents the date that management module 130 received approval of the stage 172 from the support team. In this particular example, approval of stages 1A-1C on February 10 resulted in authorization of stages 2A-2C on the same day.

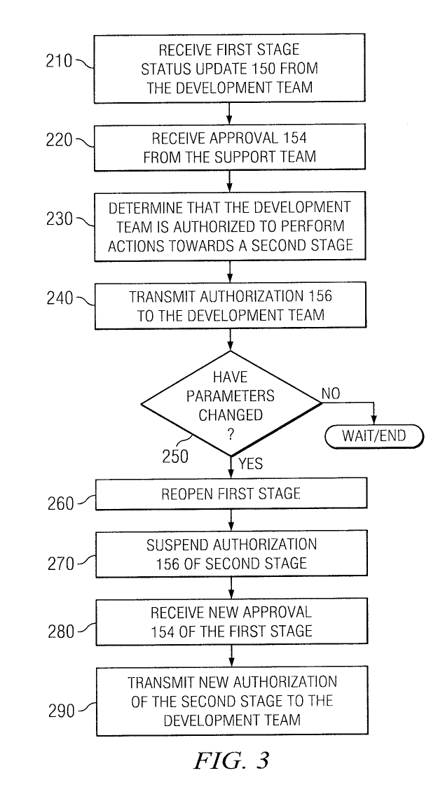

FIG. 3 shows an example method 200 for managing development of a project according to one embodiment. At step 210, management module 130 receives first stage status update 150 from the development team. At step 220, management module receives approval 154 from the support team. At step 230, management module 130 determines that the development team is authorized to perform actions towards completion of a second stage based on receipt of approval 154 for the first stage. At step 240, management module 130 transmits authorization 156 to the development team.

At step 250, management module 130 determines whether any parameters have changed regarding the first stage. If no parameters have changed, the method ends or waits for future parameter changes. If a parameter has changed, management module 130 reopens the first stage at step 260. At step 270, management module 130 suspends authorization of the second stage based on the change in status of the first stage. At step 280, management module 130 receives new approval 154 of the first stage. At step 290, management module transmits new authorization 156 to the development team.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

Although several embodiments have been illustrated and described in detail, it will be recognized that substitutions and alterations are possible without departing from the spirit and scope of the present invention, as defined by the appended claims.

To aid the Patent Office, and any readers of any patent issued on this application in interpreting the claims appended hereto, applicants wish to note that they do not intend any of the appended claims to invoke paragraph 6 of 35 U.S.C. §112 as it exists on the date of filing hereof unless the words “means for” or “step for” are explicitly used in the particular claim.

1. A project management system for managing projects in a plurality of development stages comprising at least a first stage and a second stage, each stage of the plurality of development stages representing a stage required for completion before the project enters production, the system comprising:
a development module comprising a processor and an interface, wherein the interface is operable to receive a first stage status update, the first stage status update indicating that a development team has completed the first stage for a project;
a support module comprising a processor and an interface, wherein the processor is operable to determine whether the project has additional support costs, if additional support costs do not exist, the interface is operable to receive an approval from a support team approving the development team's completion of the first stage, and if additional support costs exist, the interface is operable to receive an indication that the additional support costs are addressed; and
a management module communicatively coupled to the development module and the support module and comprising a processor and an interface, wherein the processor is operable to determine whether the development team is authorized to perform actions towards completion of the second stage based on whether the approval is received for the first stage.

2. The project management system of claim 1, further comprising:
a repository operable to store a record of the approval of the development team's completion of the first stage.

3. The project management system of claim 2, wherein the record comprises a copy of a signature provided by the support team.

4. The project management system of claim 1, the management module further operable to:
determine that at least one parameter has changed regarding the first stage;
change the first stage from a completed status to an uncompleted status; and
determine whether the development team is still authorized to perform actions towards completion of the second stage based on the change of the first stage from the completed status to the uncompleted status.

5. The project management system of claim 1, further comprising:
a repository operable to store knowledge-transfer documents associated with the project.

6. The project management system of claim 1, wherein:
the first stage comprises a plurality of sub-stages including a first sub-stage and a second sub-stage, each sub-stage of the plurality of sub-stages representing a sub-stage required for completion of the first stage;
the development module is further operable to receive a first sub-stage status update, the first sub-stage status update indicating that the development team has completed the first sub-stage for the project;
the support module is further operable to receive an approval from the support team approving the development team's completion of the first sub-stage; and
the management module is further operable to determine whether the development team is authorized to perform actions towards completion of the second sub-stage based on whether the approval is received for the first sub-stage.

7. The project management system of claim 6, further comprising:
a repository operable to store a record of the approval of the development team's completion of the first sub-stage.

8. A non-transitory computer readable medium comprising logic for execution, the logic, when executed by a processor, operable to:
receive a first stage status update, wherein a plurality of development stages comprises at least a first stage and a second stage, each stage of the plurality of development stages represents a stage required for completion before the project enters production, the first stage status update indicating that a development team has completed a first stage of the plurality of development stages for the project;
determine whether the project has additional support costs;
if additional support costs do not exist, receive an approval from a support team approving the development team's completion of the first stage;
if additional support costs exist, receive an indication that the additional support costs are addressed; and
determine whether the development team is authorized to perform actions towards completion of the second stage based on whether the approval is received for the first stage.

9. The computer-readable medium claim 8, the logic when executed being further operable to store a record of the approval of the development team's completion of the first stage.

10. The computer-readable medium claim 9, wherein the record comprises a copy of a signature provided by the support team.

11. The computer-readable medium claim 8, the logic when executed being further operable to:
determine that at least one parameter has changed regarding the first stage;
change the first stage from a completed status to an uncompleted status; and
determine whether the development team is still authorized to perform actions towards completion of the second stage based on the change of the first stage from the completed status to the uncompleted status.

12. The computer-readable medium claim 8, the logic when executed being further operable to store knowledge-transfer documents associated with the project.

13. The computer-readable medium claim 8, wherein the first stage comprises a plurality of sub-stages including a first sub-stage and a second sub-stage, each sub-stage of the plurality of sub-stages representing a sub-stage required for completion of the first stage, the logic when executed being further operable to:
receive a first sub-stage status update, the first sub-stage status update indicating that the development team has completed the first sub-stage for the project;
receive an approval from the support team approving the development team's completion of the first sub-stage; and
determine whether the development team is authorized to perform actions towards completion of the second sub-stage based on whether the approval is received for the first sub-stage.

14. The computer-readable medium claim 13, the logic when executed being further operable to store a record of the approval of the development team's completion of the first sub-stage.

15. A computerized method for managing development of a project, comprising:
receiving a first stage status update, wherein a plurality of development stages comprises at least a first stage and a second stage, each stage of the plurality of development stages represents a stage required for completion before the project enters production, the first stage status update indicating that a development team has completed a first stage of the plurality of development stages for the project;
determining whether the project has additional support costs;
if additional support costs do not exist, receiving an approval from a support team approving the development team's completion of the first stage;
if additional support costs exist, receiving an indication that the additional support costs are addressed; and
determining, using a processor, whether the development team is authorized to perform actions towards completion of the second stage based on whether the approval is received for the first stage.

16. The computerized method of claim 15, further comprising storing a record of the approval of the development team's completion of the first stage.

17. The computerized method of claim 15, further comprising:
determining that at least one parameter has changed regarding the first stage;
changing the first stage from a completed status to an uncompleted status; and
determining whether the development team is still authorized to perform actions towards completion of the second stage based on the change of the first stage from the completed status to the uncompleted status.

18. The computerized method of claim 15, further comprising storing knowledge-transfer documents associated with the project.

19. The computerized method of claim 15, wherein the first stage comprises a plurality of sub-stages including a first sub-stage and a second sub-stage, each sub-stage of the plurality of sub-stages representing a sub-stage required for completion of the first stage, the method further comprising:
receiving a first sub-stage status update, the first sub-stage status update indicating that the development team has completed the first sub-stage for the project;
receiving an approval from the support team approving the development team's completion of the first sub-stage; and
determining whether the development team is authorized to perform actions towards completion of the second sub-stage based on whether the approval is received for the first sub-stage.

20. The computerized method of claim 19, further comprising storing a record of the approval of the development team's completion of the first sub-stage.
